(19) United States
(12) Patent Application Publication
(10) Pub. No.: US 2023/0079567 A1
(43) Pub. Date: Mar. 16, 2023

(54) MULTI-WALLET COMMUNITY SERVICES WITH INTEGRATED PAYMENT SERVICES

(71) Applicant: MASTERCARD INTERNATIONAL INCORPORATED, Purchase, NY (US)

(72) Inventors: Vladimir MAMUT, Jewett, NY (US); Alexander A. POPOFF, Bellevue, WA (US); Tara NATHAN, Sherman, CT (US); Alex ZERIO, New York, NY (US); Patrick L. KILLIAN, Cottleville, MO (US)

(73) Assignee: MASTERCARD INTERNATIONAL INCORPORATED, Purchase, NY (US)

(21) Appl. No.: 17/473,589

(22) Filed: Sep. 13, 2021

(51) Int. Cl. G06Q 20/36

(52) U.S. Cl. CPC G06Q 20/367

(57) ABSTRACT

A community passport (“CP”) platform provides interoperability between community and payment services. The CP platform may store a digital identity of an enrolled user and share the digital identity across community and payment service entities. For example, a community or payment service that enrolls a user that is previously unknown to the CP platform may identify the user and establish a digital identity of the user. The digital identity may be stored at the CP platform for federation to participating services and at a multi-wallet device that is issued to the user at the time of initial enrollment. After this initial enrollment, the multi-wallet device may be used to identify the user across any other community or payment service entity known to the CP platform. Each community or payment service may issue a credential that is also stored at the multi-wallet device to access that service.

### BACKGROUND

The provision of various services to users may require trusted identity verification. This may be especially true in financial services where know-your-customer (“KYC”) rules require financial institutions to identify their customers. But identity verification is also important for other types of services, such as to render assistance to those in need. For example, a humanitarian service may render assistance to users. Without identity verification to identify users to whom assistance is rendered, there may no way of efficiently assessing effectiveness of assistance campaigns.

Government-issued identification cards (“ID cards”) may provide some level of trusted identity, but even these may be forged and may not be universally accepted to provide efficient user identification across a range of services. For example, the technology infrastructure to support tracking government-issued ID cards, whether locally at the ID card or remotely, may not sufficiently address (if at all) the need for trusted identify verification across the range or services. Furthermore, government-issued ID cards may not even be available in some parts of the world.

Even if there were a single device with a trusted digital identity that is usable across a range of services, there exists issues in integrating payment services within that single device. For example, current prepaid and other payment constructs prevent user devices from being pre-populated with prepaid credentials. Thus, it may be difficult to provide users with an integrated payment solution alongside other services that leverage a trusted digital identity via a single device that the user may use.

Another issue that may arise is that each service or payment provider may operate its respective technology stack that may be incompatible with other technology stacks. Thus, it may be difficult to not only identify a user across these technology stacks in a trusted way, but also to monitor data inflows and outflows relating to these services.

These and other issues may exist with providing a trusted digital identity across multiple community and payment services. While applicable to various types of users, these and other issues may be especially applicable to Bottom of Pyramid (“BOP”) users who are underrepresented in the financial services sector. BOP users refer to users that are socio-economically disadvantaged, especially in geographic regions where technology and financial services penetration is low.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system environment of providing interoperability among community services from multiple domains with payment services in a trusted and secure platform;

FIG. 2 illustrates an example of an architecture of the system illustrated in FIG. 1;

FIG. 3 illustrates a data flow of interactions of the system illustrated in FIG. 1;

FIG. 4 illustrates an example of transaction processing facilitated by the multi-wallet device;

FIG. 5 illustrates example architectures and interactions between a multi-wallet device and a POI device;

FIG. 6 illustrates an example data flow for value exchange transactions using the multi-wallet device;

FIG. 7 illustrates an example of a method of a multi-wallet device interacting with a POI device;

FIG. 8 illustrates an example of a method of providing interoperability between community services and payment services; and

FIG. 9 illustrates an example of a computer system that may be implemented by devices illustrated in FIG. 1.

### DETAILED DESCRIPTION

The disclosure relates to methods and systems of a community passport (“CP”) platform that provides interoperability between community and payment services with a trusted digital identity. The CP platform may store a digital identity of an enrolled user and share the digital identity across various community and payment service entities. For example, a community or payment service that enrolls a user that is previously unknown to the CP platform may identify the user and establish a digital identity of the user. The digital identity may be stored at the CP platform and at a multi-wallet device that is issued to the user at the time of initial enrollment. The community or payment service may also issue a credential that is also stored at the multi-wallet device to access that service. After this initial enrollment, the multi-wallet device may be used to identify the user across any other community or payment service entity known to the CP platform.

For example, a user that is previously unknown to the CP platform may be initially enrolled with a community service in a humanitarian domain to receive humanitarian services. The user may be issued a multi-wallet device that is loaded with the digital identity and a humanitarian services credential to access the humanitarian services. Later, the user may present the multi-wallet device to provide the trusted digital identity to a community service in the education domain to enroll to receive community services in the education domain. After this enrollment, an education services credential may be loaded to the multi-wallet device to access the education services. Still later, the user may present the multi-wallet device to provide the trusted digital identity to a financial institution to enroll to receive payment services such as a payment account. After this enrollment, a payment credential from the bank may be loaded to the multi-wallet device for payment transactions involving the payment account.

The order in which the initial enrollment occurs may vary. For example, the user may initially enroll with the financial institution and then present the multi-wallet device to subsequently enroll in one or more community services. Thus, after an initial enrollment with a community or payment service, a trusted identity of the user facilitated by the CP platform may be shared across different services, regardless of which service initially enrolled the user.

The multi-wallet device may be a chip-enabled device, such as a chipcard with an integrated circuit that provides storage and processing capabilities in a card form factor. Other form factors may be used, but the card form factor may provide a cost-effective and robust solution for users in areas in which technology penetration is low, such as for BOP users. The storage and processing capabilities of the multi-wallet device may include storage and execution of multiple applications, including a CP application, various CP mobile wallets (CPMWs) each corresponding to a respective community service, and one or more payment mobile wallets (PMWs) each corresponding to a respective payment service. Each CPMW and each PMW may be assigned with a respective application identifier (“AID”) that is known across the CP platform and participating devices.

The CP application may store or otherwise access the digital identity of the user, and user personal identifying information (“PII”). The digital identity may be data that uniquely identifies the user. For example, the digital identity may include a globally unique identifier issued by the CP platform, biometric data such as fingerprint data or iris data, and/or other unique identifying information. The digital identity and/or PII may be obtained during the initial enrollment of the user.

Each CPMW may correspond to a respective community service. For example, a community service in the health domain may have a health domain CPMW installed at the multi-wallet device and a community service in the humanitarian domain may have a humanitarian domain CPMW installed at the multi-wallet device. Depending on which one of these community services (or payment services) is to be accessed using the multi-wallet device, the CP wallet application may select an appropriate application to execute, as will be described below.

The PMW may be pre-installed in an inactivated, or dormant, state until activated. In this manner, the user may access community services using the multi-wallet device even when the user has not been issued a payment account. When the user is later issued a payment account, which may be a prepaid account processed through a payment network, the payment application may be activated so that a new payment card need not be issued to the user. Such activation may include updating an active/inactive flag or other indication to indicate that the payment application is activated. Alternatively, or additionally, loading a payment credential to the multi-wallet device may activate the PMW.

Because the multi-wallet device may be used across a range of different types of services and stores corresponding credentials of each, the CP application may select from among the CPMWs or PMWs that is to be used. When the user wishes to access a community or payment service, the user may present the multi-wallet device for interfacing with a Point of Interaction (“POI”) device. For example, the user may dip the multi-wallet device into the POI device. During an initial stage of communication, such as during a handshake communication, the POI device may transmit a listing of one or more supported AIDs. Each AID may identify a corresponding application supported by the POI device. For example, a POI device programmed to interact with the CP platform may transmit a first AID that identifies a first CPMW supported by the POI device, a second AID that identifies a second CPMW, and a third AID that identifies a PMW, indicating that the POS device supports payment services. A dedicated payment terminal may transmit only an AID relating to the PMW.

The CP application of the multi-wallet device may respond with one or more of its supported AIDs. If the payment application has not been activated, the CP application may not transmit the AID of the payment application. If multiple AIDs are supported by the POI device and the multi-wallet device, the POI device may prompt for selection of the appropriate AID. Alternatively, during the handshake communication, the POI device may transmit a specific AID, such as when an operator of the POI device is to provide a specific service. For example, a POI device used by a provider of a community service in the humanitarian domain may be programmed to transmit the AID associated with the CPMW for the humanitarian domain. A POI device that is to process a payment transaction may transmit an AID associated with the payment application.

Upon selection of an AID, the CP application may transmit the selected AID and associated credential to the POI device. The POI device may be programmed to transmit authorization requests relating to the selected AID and credential. Thus, depending on the AID and credential, the POI device may interface with community and/or payment services. It should be noted that a given POI device may transmit requests for both community and payment services or may be a dedicated payment terminal that transmits authorization requests relating only to payment services. Thus, the multi-wallet device may support POI devices that are dedicated payment terminals and POI devices that interact with the CP platform. Having described an overview of examples of operation of the CP platform and multi-wallet device, attention will now turn to a system environment of the CP platform and multi-wallet device.

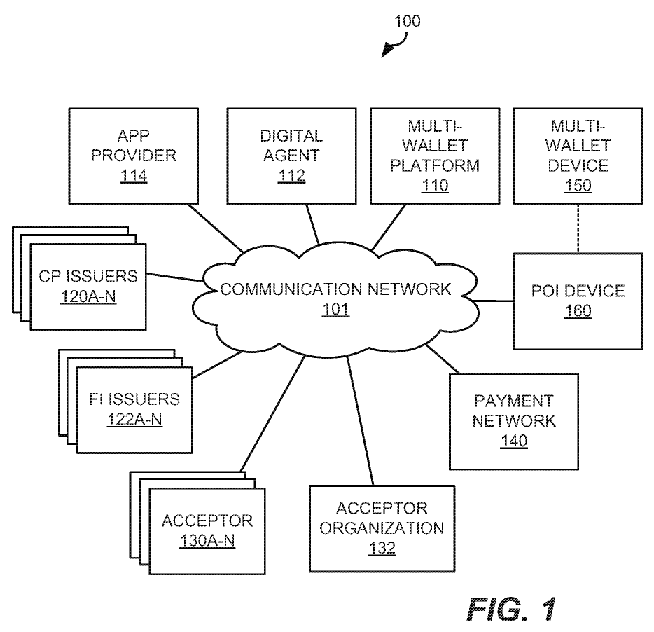

FIG. 1 illustrates an example of a system environment 100 of providing interoperability among community services from multiple domains with payment services in a trusted and secure platform. A community service may refer to a good or service that is provided to a user that may be, but is not necessarily, in exchange for payment. A domain of a community service may include, for example, a health domain, an agricultural domain, an education domain, and a humanitarian domain. A payment service may refer to the transfer of funds from a sender to a recipient. In the context of BOP users, the payment service may permit BOP users to make purchases at participating merchants or entities, such as through a payment network 140.

The system environment 100 may include a CP platform 110, a digital agent 112, an application provider (“app provider”) 114, a plurality of CP issuers 120A-N, a plurality of acceptors 130A-N, an acceptor organization (“org.”) 132, a payment network 140, a multi-wallet device 150, a point of interaction (“POI”) device 160, and/or other components. At least some of the components of the system environment 100 may be connected to one another via a communication network 101, which may include the Internet, an intranet, a Personal Area Network, a LAN (Local Area Network), a WAN (Wide Area Network), a SAN (Storage Area Network), a MAN (Metropolitan Area Network), a wireless network, a cellular communications network, a Public Switched Telephone Network, and/or other network through which system environment 100 components may communicate.

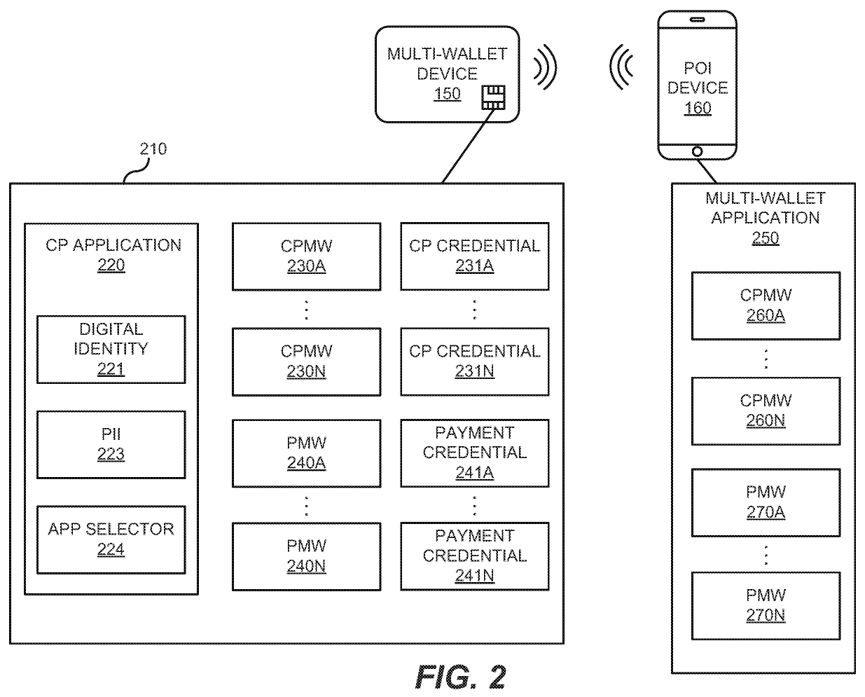

The CP platform 110 may include one or more computing devices (which may be referred to as CP platform servers) that provide trusted and shared information across multiple domains of community services and payment services to users. For example, the CP platform 110 may store a digital identity and a user profile of a user. The digital identity may be a unique user identifier that is used to uniquely identify a given user in the CP platform 110. The unique user identifier may be based on biometric data (such as a fingerprint, iris scan, facial scan, and so forth - or hash thereof), a system-generated identifier (such as an alphanumeric number or string), and/or other type of data that can uniquely identify users. The user profile may include data known about the user such as personal identifying information, ethnicity, gender, and/or other information known about the user. The user profile may include or be stored in association with the digital identity. The CP platform 110 may federate some or all of the user profile across various entities that are registered with the CP platform 110, providing trusted and secure information sharing. An example of an architecture and operation of the CP platform 110 will be described later with respect to FIG. 2.

The digital agent 112 may include an entity that enrolls other entities, devices, or applications to interface with the CP platform 110. For example, the digital agent 112 may enroll users that are issued multi-wallet devices 150, app providers 114 and their applications, CP issuers 120, FI issuers 122, acceptors 130, and/or other entities, devices, or applications. The digital agent 112 may provide various devices to entities in connection with enrollment. For example, the digital agent 112 may provide a multi-wallet device 150 to the user, a POI device 160 to an acceptor 130, and/or other devices to other entities. As used herein, the term “user of the multi-wallet device 150” will refer to a user to whom the multi-wallet device 150 was issued for the purpose of accessing community and/or payment services.

The app provider 114 may include an entity that develops and provides wallet applications that are stored and executed at the multi-wallet device 150 on behalf of CP issuers 120 and/or FI issuers 122. Each of the CP issuers 120 and/or FI issuers 122 may have their own app providers 114.

A CP issuer 120 may refer to an entity that pays for or otherwise directs the provision of a community service. A CP issuer 120 may include a government or non-government organization (“NGO”). CP issuers 120 may provide community services in various domains.

A financial institution (“FI”) issuer 122 may refer to an entity such as a bank that issues payment accounts identified by a primary account number (“PAN”). The PAN may be recognized by a payment network 140 to facilitate payments from (or to) the corresponding payment account. The payment network 140 may refer to a system of processing payments from a sender to a recipient. An example of a payment network 140 is the Mastercard® payment network. It should be noted that the CP platform 110 may be part of the payment network 140.

An acceptor 130 may refer to an entity that obtains a digital identity of the user and communicates with the CP platform 110 to facilitate provision of community or payment services to the user. For example, each acceptor 130 may operate a POI device 160 that communicates with a multi-wallet device 150 of a user to obtain the digital identity, a credential, and/or other data from the multi-wallet device 150. It should be noted that the acceptor 130 may be part of or separate from the CP issuer 120 or the FI issuer 122. For example, the acceptor 130 may be a field office of the CP issuer 120 or the acceptor 130 may be a third-party provider. In the context of community services, the acceptor 130 may interact with users to provide community services. In the context of payments, the acceptor 130 may include a merchant.

An acceptor organization 132 may refer to an organization that processes requests on behalf of an acceptor 130. In the context of community services, the acceptor organization 132 may communicate, via the CP platform 110, with a corresponding CP issuer 120 to process transactions involving the provision of community services to the user. In the context of payments, the acceptor organization 132 may be a merchant acquirer that communicates, via the CP platform 110, with an FI issuer 122.

The multi-wallet device 150 may refer to a device that includes processing and memory capabilities to store and execute a plurality of wallet applications and store and provide a digital identity of the user. For example, the multi-wallet device 150 may include a processor and a memory device. In some examples, the multi-wallet device 150 may include an integrated circuit (IC) device. A POI device 160 may refer to a device that communicates with a multi-wallet device 150 to identify a user and facilitate provision of a community or payment service. The POI device 160 may be a dedicated device that provides only payment transaction functionality or a device that provides payment transaction functionality as well as CP functionality to process community service transactions. An example of architectures and interactions between a multi-wallet device 150 and a POI device 160 will now be made with reference to FIG. 2.

Referring to FIG. 2, the multi-wallet device 150 is illustrated as having a chipcard form factor and an IC 210, which may include processing and storage (memory) capabilities. The POI device 160 is illustrated as a handheld device such as a smartphone or tablet device. The foregoing examples illustrate an implementation that facilitates provision of community and payment services to BOP users because of the cost advantages that this implementation provides. However, other types of multi-wallet devices 150 and POI devices 160 may be used to provide community and payment services to BOP and/or other users.

The IC 210 may store a unique device identifier and a pre-installed plurality of applications. The term “pre-installed” may refer to having been stored on the IC 210 before being provided to the user. The unique device identifier may uniquely identify the multi-wallet device 150. The pre-installed applications may include a CP application 220, one or more CPMWs 230 (illustrated as CPMW 230A-N), one or more payment mobile wallets (PMWs) 240 (illustrated as PMWs 240A-N), and/or other applications that may be stored and executed on the IC 210.

The CP application 220 may store or otherwise access a digital identity 221 and PII 223 of the user to which the multi-wallet device 150 is issued. As such, the multi-wallet device 150 may provide proof of identity of the user that is trusted and secured because of its association with the CP platform 110 and corresponding techniques to store and share a digital identity of the user.

The CP application 220 may include an app selector 224 that selects an appropriate wallet application (one of the CPMWs 230A-N or PMWs 240) that are also stored onboard the IC 210 to execute to facilitate a transaction with a POI device 160. Each wallet application may be identified by an application identifier (“AID”) and each wallet application may be associated with a corresponding credential (such as a CP credential 231A-N or payment credential 241A-N). The app selector 224 may store or otherwise access a list of AIDs and corresponding wallet application and/or credential.

Each CPMW 230 may be associated with a CP issuer 120. For example, a CPMW 230A may be associated with a CP issuer 120A, a CPMW 230N may be associated with a CP issuer 120N, and so on. Each CPMW 230 may be executed by the multi-wallet device 150 to access services by authenticating or otherwise identifying a corresponding CP credential 231 issued by a CP issuer 120. For example, each CPMW 230 may provide a corresponding CP credential 231 to identify and/or authenticate a user to a corresponding CP issuer 120.

Each CPMW 230 may provide functionality associated with each respective CP issuer 120. For example, a CPMW 230A of a CP issuer 120A in the health domain may provide functionality to transmit or receive health data records of the user. A CPMW 230N of a CP issuer 120N may in the humanitarian domain may provide functionality to transmit or receive data relating to humanitarian assistance provided to the user. Each PMW 240A-N may be similarly associated with a respective FI issuer 122, and each payment credential 241A-N may be used to identify or authenticate the user to the respective FI issuer 122. Instead of community services, however, each PMW 240A-N may facilitate payment transactions, such as prepaid transactions, which may be mediated by the payment network 140.

Each PMW 240 may be pre-installed in an inactive state at the multi-wallet device 150. Thus, a user may be provided with and use the multi-wallet device 150 to access community services while the PMW 240 is inactive. When a FI issuer 122 issues a payment account to the user, the multi-wallet device 150 may be provided with a payment credential 241, thereby activating the PMW 240. The term “activated” and similar terminology with respect to the PMW 240 may refer to being able to be executed by the IC 210 to cause a payment transaction to be made over the payment network. Alternatively, or additionally, the term “activated” and similar terminology with respect to the PMW 240 may refer the multi-wallet device 150 storing and providing an indication (such as an active/inactive flag) that the multi-wallet device 150 supports the PMW 240. In these examples, the multi-wallet device 150 may transmit, to a POI device 160, an indication that the PMW 240 is available at the multi-wallet device 150 when the PMW 240 is activated. On the other hand, in these examples, the multi-wallet device 150 may not transmit an indication that the PMW 240 is available at the multi-wallet device 150 when the PMW 240 is inactive (not activated).

The POI device 160 may include a processor that executes a multi-wallet application 250. The multi-wallet application 250 may interface with or otherwise execute any of the CPMW 260A-N and/or PMW 270A-N that may be stored on the POI device 160. Like the multi-wallet device 150, each of the CPMW 260A-N and/or PMW 270A-N may be associated with respective CP issuers 120A-N and/or FI issuers 122A-N. In this way, any POI device 160 that is programmed by the multi-wallet application 250 may interface with any of the CP issuers 120A-N and/or FI issuers 122A-N.

The multi-wallet application 250 may be updated by the CP platform 110 (via, for example, the digital agent 112), to provide CPMW 260A-N and/or PMWs 270A-N to be installed or updated. It should be further noted that the POI device 160 may include a payment terminal that does not interface with the community services and only provides payment services, such as a conventional point of sale terminal or payment card reader. In this example, the payment terminal may still interface with the multi-wallet device 150 through a PMW 240. As such, the multi-wallet device 150 may be used to participate in transactions with a POI device 160 that includes the multi-wallet application 250 and/or with a POI device 160 that is, for example, a conventional payment terminal. For examples in which the POI device 160 is a conventional payment terminal, the multi-wallet device 150 may appear to the POI device 160 as payment card, providing seamless backward compatibility.

In operation, the app selector 224 may interact with the POI device 160 to exchange application capabilities and select a wallet application that is to be executed for facilitating the transaction with the POI device 160. For example, when the multi-wallet device 150 is dipped into the POI device 160, they may participate in a handshake communication with one another.

In some examples, during the handshake communication, the POI device 160 may transmit, to the multi-wallet device 150, a list of AIDs that each identify an application supported by the POI device 160. The app selector 224 may consult its list of supported AIDs to determine whether there are matching AIDs. If so, the app selector 224 may respond with an AID or list of AIDs supported by the multi-wallet device 150 and a corresponding credential, which may include a token such as a VPAN. If more than one AID is supported, the POI device 160 may prompt the user (that is issued the multi-wallet device 150) or the operator of the POI device 160 to select an appropriate AID. For example, if the transaction relates to a particular community service, the corresponding AID for the CPMW 230 may be selected. If the transaction relates to a payment transaction, the corresponding AID for the PMW 240 may be selected. If none of the list of AIDs from the POI DEVICE 160 is supported, the app selector 224 may provide a response indicating that no supported AID is available.

In some examples, during the handshake communication, the POI device 160 may transmit a particular AID that is to be used for the transaction. The app selector 224 may consult its list of supported AIDs to determine whether the particular AID is in the list of supported AIDs. If so, the app selector 224 may respond with the particular AID to indicate that the AID is supported. In either example, upon selection of the appropriate AID, the multi-wallet device 150 and the POI device 160 may each execute respective wallet applications identified by the selected AID to conduct the transaction. For example, a selected one of the CPM W 260A-N or PMW 270AN at the POI DEVICE 160 may interact with a corresponding CPMW 230A-N or PMW 240A-N at the multi-wallet device 150. It should be noted that if none of the PMWs 240 are activated, then the app selector 224 may not indicate any of these as being supported.

In some examples, the POI device 160 may perform local and/or remote user authentication (such as via biometric authentication, pre-stored secret such as a personal identification number, and/or other user authentication). Such authentications may be encoded by each respective CPMW 230A-N and/or PMW 240A-N. For example, the POI DEVICE 160 may conduct community service credential validation, payment credential validation, product/application workflows, any local authorization such as for offline stored value accounts, transaction routing, and/or other functions.

Although depicted as a card device, the multi-wallet device 150 may include other form factors (not illustrated) such as a wearable device having the IC 210, a smartphone or other portable computing device having a processor and a memory that provide functions of the IC 210, and/or other form factor. In some of these other examples, such as is the case with a smartphone capable of network communications, the multi-wallet device 150 may not be required to be in communication with a POI device 160 to receive an activation of the PMW 240.

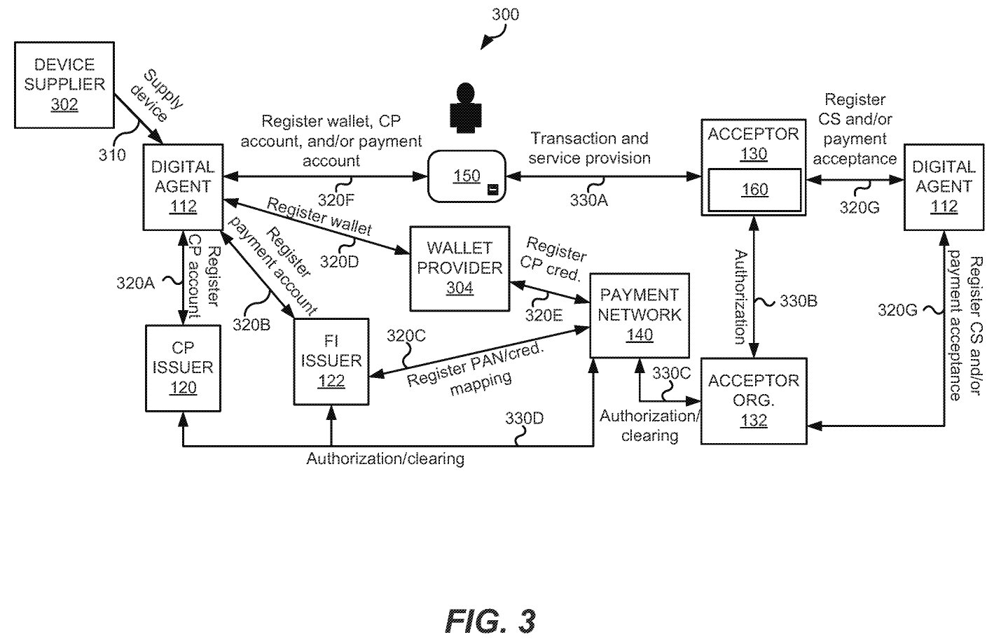

Having described an example of the multi-wallet device 150 and POI device 160, attention will now to an example of interactions for registration and transaction processes. For example, FIG. 3 illustrates a data flow 300 of interactions of the system environment 100 illustrated in FIG. 1. FIG. 3 will make reference to the previous figure as well.

At 310, a device supplier 302 may supply multi-wallet devices 150 to a digital agent 112. The multi-wallet devices 150 may be “blank” chip cards that with a pre-installed CP application 220, which may provide a common interface for CPMWs 230A-N and PMWs 240AN. At the time of provision, the multi-wallet devices 150 may not store any CP credentials 231AN and may not store any payment credentials 24A-N.

Various registration data flows will be described with reference to 320A-G. For example, 320A-C will refer to registering a user with a CP issuer 120 to enroll a CP account and registering a user with a FI issuer 122 to enroll a payment account for the user. 320D-F will describe registering the CP application 220 with the various accounts. Various transaction data flows will be described with reference to 330A-D. It should be noted that the registration and transaction data flows are not necessarily described in any particular order. It should be further noted that, although not illustrated in FIG. 3 for convenience, the digital agent 112 may communicate with the CP platform 110 to facilitate the registrations.

At 320A, the digital agent may enroll a user to use community services of a CP issuer 120. For example, if enrolling the user for the first time, the digital agent 112 may obtain and provide a digital identity, PII, and/or other information known about the user to the CP issuer 120. Otherwise, the digital agent 112 may use a POI device 160 to obtain such information from the user’s multi-wallet device 150.

In response, the CP issuer 120 may authenticate the identity information with the payment network 140 and/or the CP platform 110. Upon authentication, the CP issuer may issue a CP account for the user. The CP account may be identified by a CP account number. To leverage the trust and security of the payment network 140, the CP account number may be formatted as a primary account number (“PAN”). A PAN may include multiple digits, such as 14-16 digits, that uniquely identifies an account. In this instance, the CP issuer 120 may leverage the PAN format and recognition on the payment network 140 to identify the CP account. Each PAN may encode an identification of the CP issuer 120. For example, the first N digits (where N is an integer) of the PAN may include a bank identification number (“BIN”) or Interbank Card Association (“ICA”) number that identifies a corresponding CP issuer 120. A PAN that identifies a CP account will also be referred to as a “CP PAN.”

To reduce the potential of exposing PANs, each PAN may be tokenized. For example, a CP issuer 120 may generate a virtual primary account number (“VPAN”) that tokenizes the PAN and is stored in association with the PAN. The VPAN may include a randomly generated number. In some examples, in addition to the randomly generated number, a portion of the VPAN may encode a source of the CP issuer 120, such as by including a BIN or ICA. The VPAN may be transmitted across the network for use as a credential but the PAN is not. Transmission of the VPAN instead of the PAN may protect the PAN from exposure. The term “credential” may be referred to interchangeably herein as a “token” or a “VPAN.” Thus, a CP credential 231 may be interchangeably referred to as a CP token or CP VPAN and a payment credential 241 may be interchangeably referred to as a payment token or a payment VPAN. It should be noted that EUROPAY/MASTERCARD/VISA (“EMV”) tokens may be used via OTA updates.

At 320B, the digital agent 112 may register a payment account with an FI issuer 122. For example, the digital agent 112 may provide the digital identity, PII, and/or other information about the user to the FI issuer 122. The FI issuer may issue a payment account for the user. The payment account may be identified by a payment account number, which may be formatted as a PAN. Such PAN for the payment account may be referred to as a payment PAN to distinguish from a CP PAN. The payment PAN may be tokenized to a payment VPAN.

At 320C, the FI issuer 122 may register the payment PAN and payment credential 241 to the payment network 140, which may securely store a PAN mapping that stores the payment PAN and the payment VPAN.

At 320D, digital agent 112 may register the CP application 220 with a wallet provider 304, which may develop the CP application 220.

At 320E, the wallet provider 304 may register the CP PAN and the CP credential 231 with the payment network 140, which may store the CP credential 231 in association with the CP PAN.

The payment network 140 (and/or the CP platform 110) may store or otherwise access the PAN mapping. In this manner, when a credential (whether a CP credential 231 or payment credential 241) is received in connection with a request, the payment network 140 and/or the CP platform 110 may look up the corresponding CP PAN or payment PAN and then route the request accordingly.

At 320F, the digital agent 112 may register a wallet account (an account issued by the CP platform 110), a CP account issued by a CP issuer 120 described at 320A, and/or payment account issued by a FI issuer 122 described at 320B with the multi-wallet device 150. To do so, the digital agent 112 may transmit, to the multi-wallet device 150 for storage at the multi-wallet device 150, the CP credential 231 (the CP VPAN), the payment credential 241 (the payment VPAN), and/or other information from the registration processes described at 320A-E. For example, the digital agent 112 may load the CP credential 231, payment credential 241, and/or other credentials (tokens or VPANs) for which the user has been enrolled to the multi-wallet device 150.

It should be noted that the digital agent 112 may register CP accounts of different domains of community services and payment accounts at different times. For example, the digital agent 112 may register a CP account for a user to receive community services in a humanitarian domain, which may be provided by a CP issuer 120A such as a humanitarian relief organization. If the registration of the CP account in the humanitarian domain is the first time that the user has been registered with the CP platform 110, the digital agent 112 may provide the user with a multi-wallet device 150, such as one of the blank multi-wallet devices 150 from the device supplier 302. Otherwise, if the user has already been registered with the CP platform 110 and already possesses a multi-wallet device 150, the digital agent 112 may register a CP account associated with the CP issuer 120A. At a later time, if the user is to receive community services in the education domain, the digital agent 112 (which may be the same or different digital agent 112 than used for the humanitarian domain) may register a CP account associated with a CP issuer 120B in the education domain.

At 320G, the digital agent may register the community service or payment acceptance. For example, the digital agent 112 may register an acceptor 130 that operates a POI DEVICE 160. The digital agent 112 may register an acceptor organization 132. In this way, various operators that accept CP and/or payment transactions may be registered to process transactions across the payment network 140 and/or CP platform 110. Upon registration to one or more community or payment services, a user may use the multi-wallet device 150 to receive community or payment services.

For example, at 330A, the multi-wallet device 150 may be presented to and read by a POI device 160 operated by an acceptor 130. The multi-wallet device 150 may transmit a CP credential 231 or payment credential 241 to the POI device 160, depending on whether the transaction for a community service or payment based on the selected AIDs as illustrated in FIG. 2.

At 330B, the POI device 160 may transmit an authorization request to the acceptor organization 132. The authorization request may include the CP token or payment token. In some examples, the authorization request may encode the type of request being made, such as a CP request or a payment request. The acceptor organization 132 may be an entity that processes the authorization request on behalf of the provider or a merchant acquirer that processes the authorization request on behalf of the merchant.

At 330C, the acceptor organization 132 may submit authorization and clearing requests through the payment network 140. The authorization and clearing requests may include the CP token or the payment token. At 330D, the payment network 140 may obtain the CP PAN based on the CP credential 231 and the PAN mapping or the payment PAN based on the payment credential 241 and the PAN mapping. The payment network 140 may identify the appropriate entity based on the CP PAN or the payment PAN. The payment network 140 may route the authorization and clearing requests to the appropriate CP issuer 120 or FI issuer 122. For example, community service transactions may be routed to appropriate CP issuers 120 for authentication and approval. Similarly, payment transactions may be routed to appropriate FI issuers 122 for authentication, approval, and settlement.

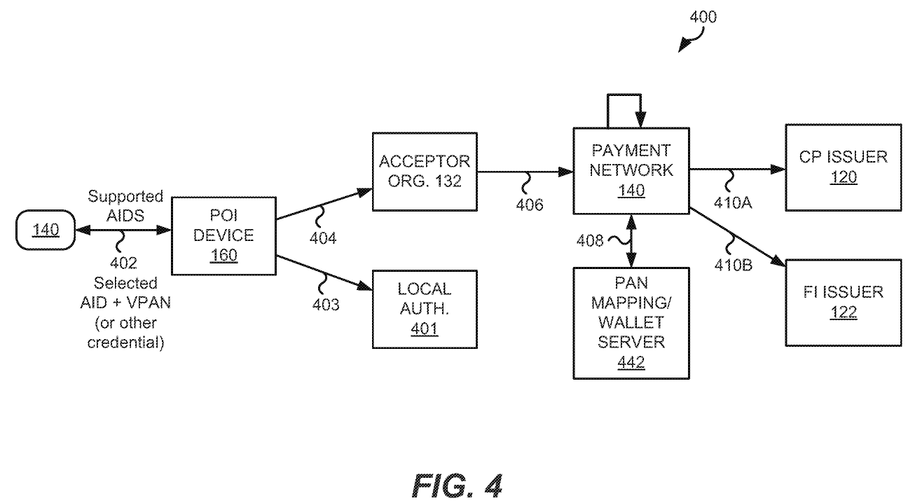

Further details of transaction processing will now be described. For example, FIG. 4 illustrates an example of transaction processing facilitated by the multi-wallet device 150. At 402, the multi-wallet device 150 and the POI device 160 may initiate communication with one another. For example, a user may dip the multi-wallet device 150 into the POI device 160 if the multi-wallet device 150 is a chip card, may bring the multi-wallet device 150 into range (such as near-field communication (NFC) or Bluetooth® range) of the POI device 160 if the multi-wallet device 150 is equipped with NFC or Bluetooth devices, and/or the user may initiate a mobile application if the multi-wallet device 150 is a network-capable device such as a smartphone. The POI device 160 may transmit a list of one or more supported AIDs and the multi-wallet device 150 may respond with a selected AID supported by the multi-wallet device 150 and a credential, such as a VPAN associated with the selected AID.

In some examples, the POI device 160 may authenticate the user according to the authentication method specified by wallet application identified by the selected AID. For example, the CPMW 260A may use biometric authentication via biometric sensors onboard the POI device 160 or multi-wallet device, the CPMW 260B may use password authentication, and the PMW 270 may use biometric authentication. Upon authentication, the POI device 160 may proceed to either online or offline authorization, depending on the selected AID.

For offline authorization, at 403, the POI device 160 may conduct local authorization according to the selected wallet application. For example, an offline voucher or offline SVA may be locally authorized by the POI DEVICE 160 by consulting a voucher amount or SVA amount stored at the multi-wallet device 150 to ensure that the voucher amount or SVA amount is sufficient to cover the current transaction amount and/or to apply other local authorization rules for authorizing voucher, SVA, or other locally authorized transactions. Upon authorization of the transaction amount, the POI DEVICE 160 may instruct the selected wallet application at the multi-wallet device 150 to update the voucher, SVA, or other locally-authorized amount.

For online authorization, at 404, the POI device 160 may transmit an authorization request message to an acceptor organization 132 via a network, such as the communication network 101 illustrated in FIG. 1. The authorization request message may include the VPAN or other credential. It should be noted that the authorization request message may include other transaction information specific to the type of transaction. For example, a CPMW 260A may include information in the authorization request message that is specific to a respective community service to be provided to the user. The PMW 270 may include information in the authorization request message that is specific to payments, such as a payment amount.

At 406, the acceptor organization 132 may transmit the authorization request message with the VPAN or other credential to the payment network 140.

At 408, the payment network 140 may consult the PAN mapping and wallet server 442 to identify a PAN from the VPAN. When the VPAN relates to a CP issuer 120, the PAN may refer to a CP account number that identifies a corresponding CP account. When the VPAN relates to a FI issuer 122, the PAN may refer to a traditional PAN (one that identifies a payment account).

The PAN mapping and wallet server 442 may store a mapping between PANs and corresponding VPANs. A PAN may encode an identifier for an issuer that issued the PAN. For example, the CP account number may encode a BIN or ICN that uniquely identifies the CP issuer 120 that issued the CP account identified by the CP account number. Similarly, a traditional PAN may encode a BIN or ICN that uniquely identifies the FI issuer 122 that issued the payment account identified by the PAN. The identities of the CP issuer 120 and FI issuer 122 may be stored in association with respective BINs in a routing table.

The routing table may store addresses, such as network addresses of servers, that are responsible for receiving requests from the payment network 140 in association with an identity of the responsible entity. For example, the CP account number may be used to identify the CP issuer 120 to which requests relating to community services provided by that CP issuer 120 are to be routed. The routing table may store an association between the identity of the CP issuer 120 and the address to which to route requests for that CP issuer 120. Similarly, the PAN may be used to identify the FI issuer 122 to which requests relating to payments are to be routed. For example, the PAN may encode a BIN or ICA that identifies the FI issuer 122. The routing table may store an association between the bank identification number and a network address for the FI issuer 122.

As such, at 410A or 410B, the payment network 140 may route the authorization request to the CP issuer 120 or the FI issuer 122 based on the PAN mapping. The CP issuer 120 or the FI issuer 122 may then conduct authorization procedures based on their respective authorization rules.

In some examples, the PAN mapping and wallet server 442 serve as a digital wallet server for prepaid payment cards. In this capacity, the PAN mapping and wallet server 442 may store values of prepaid accounts and may process authorizations for prepaid accounts.

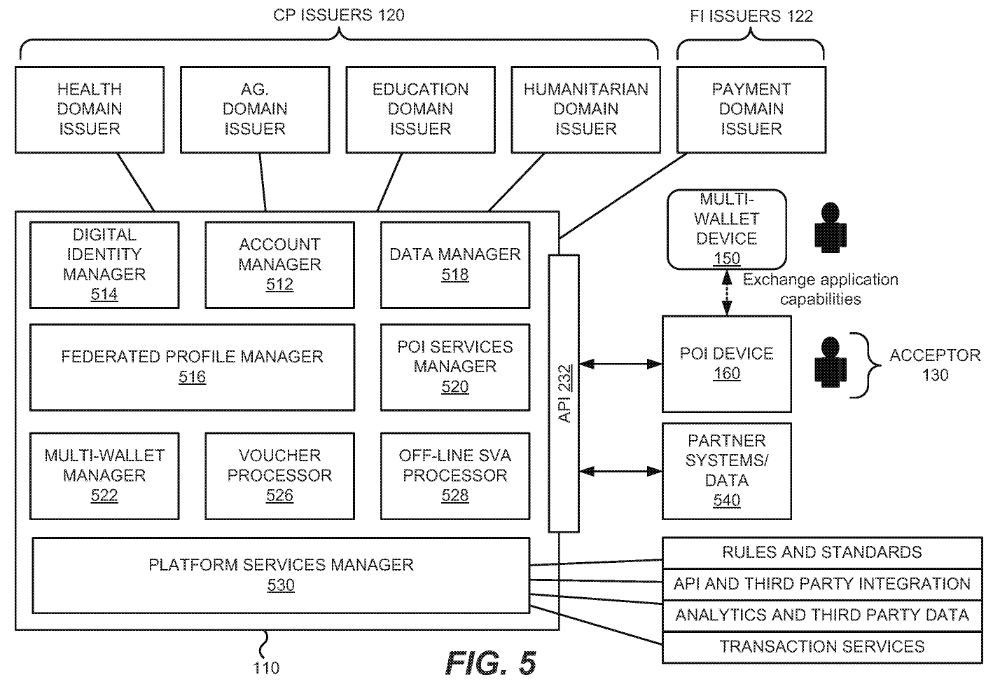

FIG. 5 illustrates an example of an architecture and operation of the system illustrated in FIG. 1. The CP platform 110 may provide functionality that may be implemented as instructions executed at a processor of one or more computing devices of the CP platform 110. Alternatively, or additionally, the functionality that may be implemented as a hardware module. Whether implemented as instructions or hardware, the functionality may be provided by an account manager 512, a digital identity manager 514, a federated profile manager 516, a POI services manager 518, a multi-wallet manager 522, a voucher processor 526, an offline stored value accounts (“SVA”) processor 528, a platform services manager 530, and/or other functionality. These and other functionality may be provided, to remote devices such as POI devices 160 and devices of the CP issuers 120 and FI issuers 122, via an Application Programming Interface (“API”) 532.

The account manager 512 may generate and maintain accounts associated with various entities. For example, the account manager 512 may receive enrollment and onboarding data from the digital agent 112 when the digital agent 112 enrolls an entity, application, or device. The account manager 512 may generate an account identifier and store the enrollment and onboarding data in association with the account identifier. For example, an account identifier may store a user account that stores user information of a user, CP issuer information of a CP issuer 150, FI issuer information of a FI issuers 122, acceptor information of an acceptor 130, acceptor organization information of an acceptor organization 132, and/or data relating to other entities that interface with the CP platform 110. The user account may be updated to include an indication of community and/or payment services received by the user and/or other updated information of relating to the user. Likewise, other accounts may be similarly updated with information. For example, a CP issuer account may be updated with indications of services provided to recipients.

The digital identity manager 514 may store and maintain digital identities of users. Each digital identity may be associated with a corresponding user account. For example, at the time of initial enrollment, biometric data (such as fingerprint, iris scan, and so forth) may be obtained from the user. The biometric data may be hashed using a cryptographic hashing algorithm such as from a secure hashing algorithm (“SHA”) family of algorithms, including SHA-256. The biometric hash may be stored in association with identifying information of the user at the CP platform 110. In this manner, a user may be verified by comparing biometric input of a user to be authenticated and the biometric hash of the user.

The federated profile manager 516 may federate a portion or all of a user profile. The user profile may include personal identifying information (PII) of the user to the extent that sharing is permitted, digital identity of the user, and/or other data relating to the user or receipt of community and/or payment services by the user. For example, upon request, such as when an issuer (CP issuer 120 or FI issuer 122) is enrolling a user, the federated profile manager 516 may transmit all or a portion of the user profile so that the issuer may complete Know-Your-Customer (“KYC”) procedures or otherwise obtain a trusted identity of the user.

The data manager 518 may receive, store, and provide data from transactions associated with each of the CP issuers 120 and FI issuers 122. For example, the data manager 518 may receive health transaction data (which may be anonymized) associated with a CP issuer 150 in a health domain. When a user presents a multi-wallet device 150 issued to that user for receiving health services, a POI device 160 operated by a healthcare provider may transmit transaction data relating to the health services to the data manager 518, such as via the API 532. The data manager 518 may store the transaction data in association with a user account, which may be identified by the digital identity of the user. The data manager 518 may also store the transaction data in association with a CP issuer account of the CP issuer 150 in the health domain. In this manner, a record of the transaction data may be stored in association with both the user account and the CP issuer account. Other transactions from other CP issuers 120 and/or FI issuers 122 may similarly be received and stored.

The POI services manager 520 may manage wallet applications that are supported across POIs 160. For example, the POI services manager 520 may store supported community services application 161A-N and PMW 270 to ensure that a given POI device 160 is provided with an appropriate wallet application or set of wallet applications. The POI services manager 520 may also ensure that a given POI device 160 is provided with a current version of a given wallet application.

Likewise, the multi-wallet manager 522 manage the various wallet applications for multi-wallet devices 150. For example, the multi-wallet manager 522 may store supported CPMWs 230A-N and PMWs 240A-N to ensure that a given multi-wallet device 150 is provided with an appropriate wallet application or set of wallet applications. The multi-wallet manager 522 may also ensure that a given multi-wallet device 150 is provided with a current version of a given wallet application. For instances in which the multi-wallet device 150 has network connectivity, the multi-wallet manager 522 may interface with the multi-wallet device 150 to provide “over-the-air” updates. In other examples in which the multi-wallet device 150 does not have network connectivity (such as when the multi-wallet device 150 is a chip card), the multi-wallet manager 522 may interface with the multi-wallet device 150 when the multi-wallet device 150 is in communication with an online POI device 160.

The voucher processor 526 may process vouchers facilitated by multi-wallet device 150. A voucher may refer to an indication, stored on the multi-wallet device 150 and/or user account, that the user is entitled to receive a good or service (usually a community service). The voucher processor 526 may facilitate provision of the good or service by processing the voucher through the payment network 140.

The offline SVA processor 528 may process payments from an SVA facilitated by the multi-wallet device 150. An SVA may refer to a prepaid account from which funds may be transferred. The multi-wallet device 150 may store an SVA issued by a FI issuers 122 or other SVA sponsor.

The platform services manager 530 may provide services to various entities. Such services may include storage and implementation of rules and standards, provision of API and third-party integrations, analytics and third-party data, and transaction services, among others. The rules and standards may be customized by each entity. For example, a CP issuer 150 may specify rules and standards by which a corresponding community service is to be provided to a user. The rules and standards may, for example, specify a timing or allocation of community services, a level of user authentication required (such as biometric or password, offline or online, and so forth), and/or other rules and standards. The provision of an API (such as API 532) and third-party integrations may facilitate a standardized way to interface with the CP platform 110. For example, the API 532 may provide a set of standardized API calls into and out of the CP platform 110 that POI devices 160, partner systems/data 540, and/or other devices may use. Because the CP platform 110 may serve as a routing point for various community and payment services, the analytics and third-party data services may provide data regarding community or payment services rendered to users. As such, various issuers may be able to keep track of services provided to users. The transaction services may process transactions, whether community service transactions that facilitate the provision of community services or payment transactions that facilitate payments through the payment network 140. The transaction services may serve as a routing point to various parties.

The API 532 may be implemented using a RESTful (REST) Application Programming Interface (API), a Simple Object Access Protocol (SOAP) interface, and/or other type of interface that may provide an interface to the CP platform 110. The API 532 may expose API calls that entities use to transmit data to the CP platform 110 and/or to one another. A given API call may therefore invoke a particular function with one or more parameter input arguments. These parameter input arguments may take, as input, various data. For example, a request or message described herein may be made to or from the CP platform 110 via an API call that includes a message with parameter values.

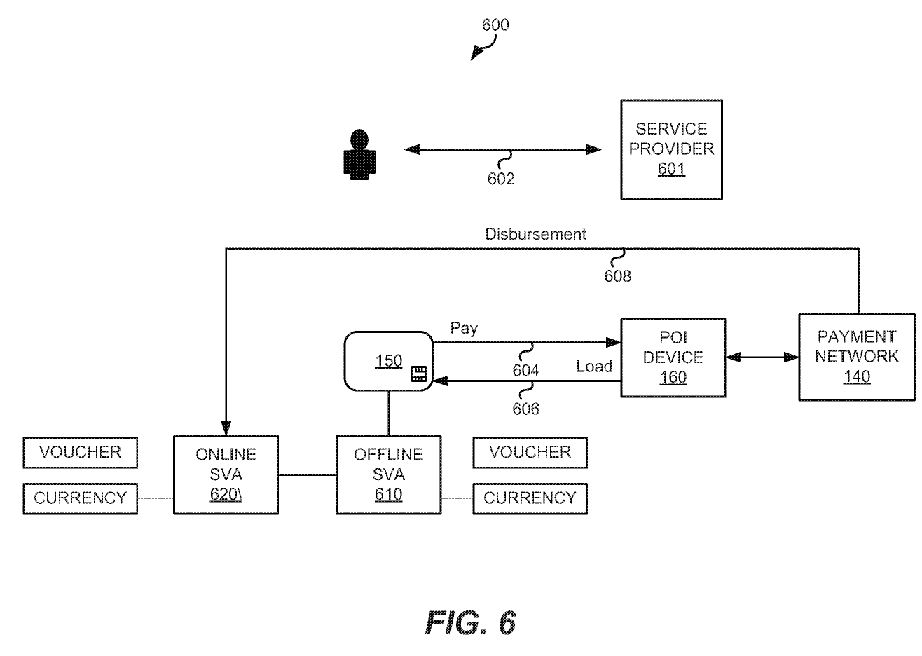

FIG. 6 illustrates an example data flow 600 for value exchange transactions using the multi-wallet device 150. Value exchange transactions may refer to a transaction that includes the exchange of value between a user and a provider. Value exchange transactions may be integrated with community service functions provided the multi-wallet device 150. For example, a value exchange transaction 602 may occur between a user and service provider 601. In connection with the value exchange transaction 602, at 604 the multi-wallet device 150 may provide a payment to the POI device 160, which may be operated by the service provider 601. The payment may via offline SVA 610 or online SVA 620. Payments via offline SVA 610 may be locally authorized by the POI device 160, while payments via online SVA 620 may be made through authorization requests made to the payment network 140. In either offline SVA 610 or online SVA 620, payments may be made through vouchers and/or currency (such as fiat currency) in the offline SVA 610 or online SVA 620.

In some examples, the multi-wallet device 150 may receive a value (digital vouchers or currency) to be loaded to the offline SVA 610 or online SVA 620. For example, at 606, the POI device 160 may transmit an indication of the load value to the multi-wallet device 150. This may occur for examples in which the multi-wallet device 150 is not network-capable, such as for chipcards. In these examples, the POI device 160 may receive an indication of the load value from the payment network 140 in connection with the value exchange transaction 602. For example, the payment network 140 may recognize the multi-wallet device 150 and transmit, to the POI device 160, an indication of the load value that is to be provided to the multi-wallet device 150. The multi-wallet device 150 may be slated to receive the load value based on loading of a prepaid account associated with the multi-wallet device 150 or voucher or currency from a government agency or NGO. Alternatively, or additionally, the payment network 140 may facilitate disbursements 608 of the load value via the online SVA 620 for the multi-wallet device 150.

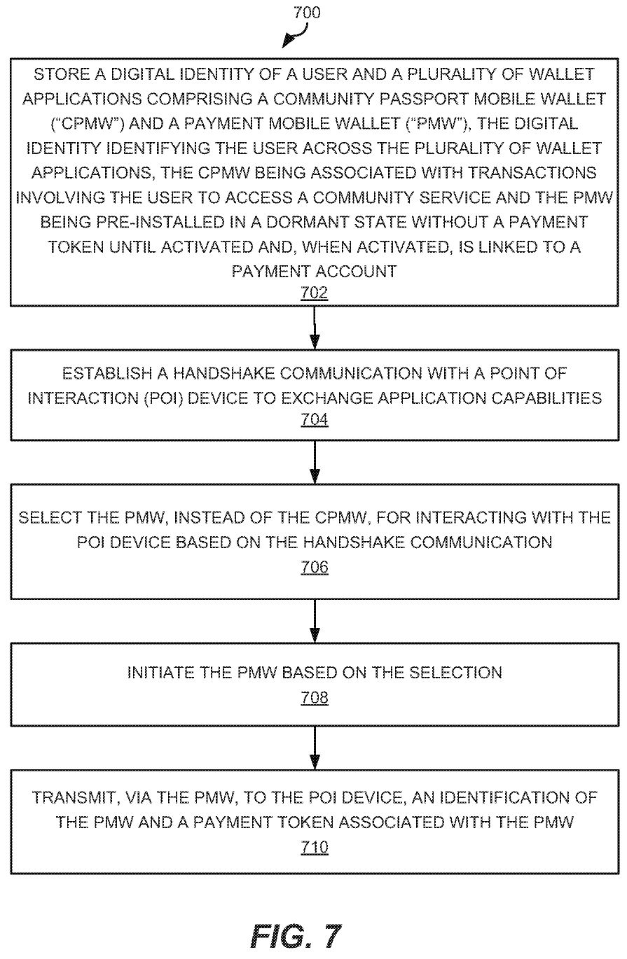

FIG. 7 illustrates an example of method 700 of a multi-wallet device 150 interacting with a POI device 160.

At 702, the method 700 may include storing a digital identity (such as a digital identity 221) of a user and a plurality of wallet applications comprising a community passport mobile wallet (“CPMW”, such as a CPMW 230) and a payment mobile wallet (“PMW”, such as a PMW 240). The digital identity may identify the user across the plurality of wallet applications. For example, by virtue of the digital identity being shared via the CP platform 110, the digital identity may be used to identify the user when enrolling a user to use a wallet application. The CPMW may be associated with transactions involving the user to access a community service (such as provided by a corresponding CP issuer 120) and the PMW being pre-installed in a dormant state without a payment token until activated and, when activated, is linked to a payment account, such as a prepaid or other payment account issued by a FI issuer 122.

At 704, the method 700 may include establishing a handshake communication with a POI device (such as POI device 160) to exchange application capabilities.

At 706, the method 700 may include selecting the PMW, instead of the CPMW, for interacting with the POI device based on the handshake communication.

At 708, the method 700 may include initiating the PMW based on the selection. For example, the multi-wallet device 150 may execute the PMW.

At 710, the method 700 may include transmitting, to the POI device, an identification of the PMW and a payment token associated with the PMW.

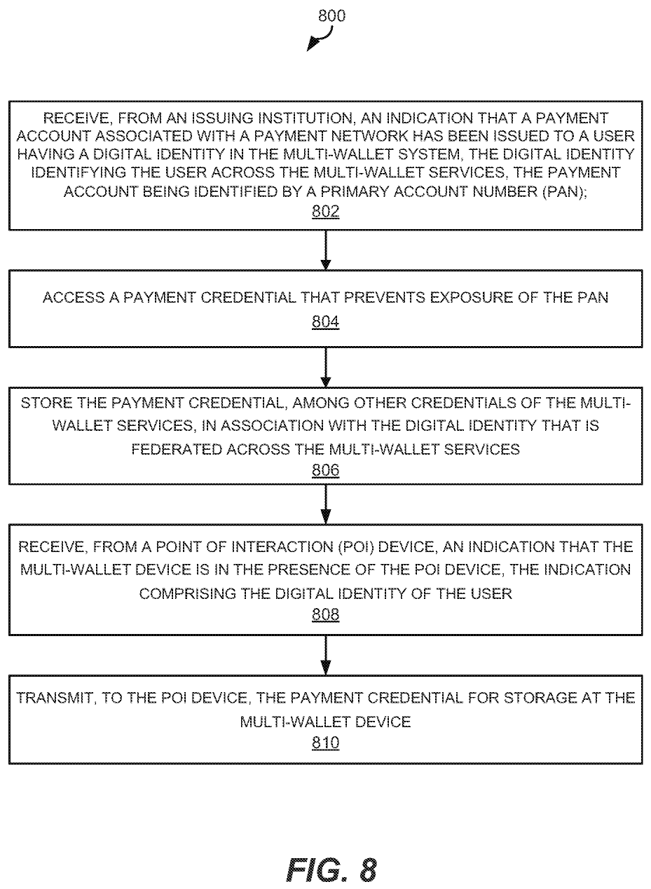

FIG. 8 illustrates an example of a method 800 of providing interoperability between community services and payment services.

At 802, the method 800 may include receiving, from a wallet provider that provides a multi-wallet application stored at a multi-wallet device of a user, a digital identity of the user and a first CP token that identifies a first CP account issued to the user to access first community services of a first CP issuer, the first CP token also having been provided to the multi-wallet device.

At 804, the method 800 may include generating a user profile comprising the digital identity of the user.

At 806, the method 800 may include federating at least a portion of the user profile to a financial institution (FI) issuer that issues a payment account to the user based on the federated user profile, the payment account being associated with a payment token that is provided to the multi-wallet device and is stored in association with a PAN in the mapping so that the multi-wallet device is used for access to the first community service and the payment account.

At 808, the method 800 may include generating a first account that stores first community services transaction data relating to the first community services provided to the user when the multi-wallet device is presented by the user to receive the first community services.

At 810, the method 800 may include generating a second account that stores payment data relating to payments made from the payment account when the multi-wallet device is presented by the user to make the payments.

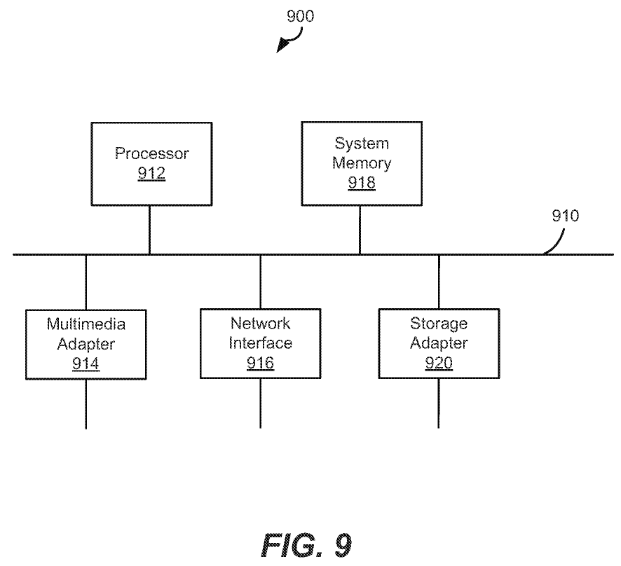

FIG. 9 illustrates an example of a computer system 900 that may be implemented by devices illustrated in FIG. 1. The computer system 900 may be part of or include the system environment 100 to perform the functions and features described herein. For example, various ones of the devices of system environment 100 may be implemented based on some or all of the computer system 900.

The computer system 900 may include, among other things, an interconnect 910, a processor 912, a multimedia adapter 914, a network interface 916, a system memory 918, and a storage adapter 920.

The interconnect 910 may interconnect various subsystems, elements, and/or components of the computer system 900. As shown, the interconnect 910 may be an abstraction that may represent any one or more separate physical buses, point-to-point connections, or both, connected by appropriate bridges, adapters, or controllers. In some examples, the interconnect 910 may include a system bus, a peripheral component interconnect (PCI) bus or PCI-Express bus, a HyperTransport or industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 910 may allow data communication between the processor 912 and system memory 918, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 912 may control operations of the computer system 900. In some examples, the processor 912 may do so by executing instructions such as software or firmware stored in system memory 918 or other data via the storage adapter 920. In some examples, the processor 912 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 914 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 916 may provide the computer system 900 with an ability to communicate with a variety of remove devices over a network such as the communication network 101 illustrated in FIG. 1. The network interface 916 may include, for example, an Ethernet adapter, a Fibre Channel adapter, and/or other wired- or wireless-enabled adapter. The network interface 916 may provide a direct or indirect connection from one network element to another, and facilitate communication and between various network elements.

The storage adapter 920 may connect to a standard computer readable medium for storage and/or retrieval of information, such as a fixed disk drive (internal or external).

Other devices, components, elements, or subsystems (not illustrated) may be connected in a similar manner to the interconnect 910 or via a network such as the communication network 101. The devices and subsystems can be interconnected in different ways from that shown in FIG. 9. Instructions to implement various examples and implementations described herein may be stored in computer-readable storage media such as one or more of system memory 918 or other storage. Instructions to implement the present disclosure may also be received via one or more interfaces and stored in memory. The operating system provided on computer system 900 may be MS-DOS®, MS-WINDOWS®, OS/2®, OS X®, IOS®, ANDROID®, UNIX®, Linux®, or another operating system.

Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number. For example, “130A-N” does not refer to a particular number of instances of 130, but rather “two or more.”

The data stored by the CP platform server 110 may be stored and accessed from one or more databases. The databases may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific embodiments described herein. In addition, components of each system and each process can be practiced independent and separate from other components and processes described herein. Each component and process also can be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIG. 1.

It should be noted that different ways to identify a user to authenticate that user for access to community and/or payment services may be used, without the multi-wallet device 150, while still leveraging the features and improvements of the CP platform 110. For example, a user may be provided with identifying data, such as unique username or other alias that is stored in association with the digital identity, a QR code that encodes the digital identity, and/or other information that the user may use to convey the digital identity of the user. A POI device 160 may obtain the information from the user, such as by entering the username or scanning the QR code. The POI device 160 may obtain the digital identity from the CP platform 110, which may also seek authentication of the user. The user may provide biometric or other authentication input to the POI device 160, which may locally compare such authentication input or may transmit the authentication input to the CP platform 110 for authentication. If the user is authenticated, the CP platform 110 may present a listing of community and/or payment services for which the user is enrolled and the POI device 160 may select an appropriate service to transact. Alternatively, upon user authentication, the POI device 160 may transmit an identification of a requested service to the CP platform 110, which may respond with an indication that the user is or is not enrolled to use the requested service.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a multi-wallet device comprising an integrated circuit (IC) to:
store a digital identity of a user and a plurality of wallet applications comprising a community passport mobile wallet (“CPMW”) and a payment mobile wallet (“PMW”), the digital identity identifying the user across the plurality of wallet applications, the CPMW being associated with transactions involving the user to access a community service and the PMW being pre-installed in a dormant state without a payment token until activated and, when activated, is linked to a payment account;
establish a handshake communication with a point of interaction (POI) device to exchange application capabilities;
select the PMW, instead of the CPMW, for interacting with the POI device based on the handshake communication;
initiate the PMW based on the selection; and
transmit, via the PMW, to the POI device, an identification of the PMW and a payment token associated with the PMW.

2. The multi-wallet device of claim 1, wherein prior to activation of the PMW, the IC is to:
receive, during a registration process, a payment token issued to the user identified by the digital identity;
store the payment token to be accessible to the PMW; and
activate, responsive to receipt of the payment token, the PMW.

3. The multi-wallet device of claim 1, wherein to exchange application capabilities, the IC is to provide an indication that the PMW is activated only upon activation of the PMW.

4. The multi-wallet device of claim 1, wherein the IC is further to:
receive, from the POI device, an indication of a load value to be loaded onto a stored value account (“SVA”) associated with the user; and
add the load value to the SVA stored locally at the IC.

5. The multi-wallet device of claim 4, wherein the load value comprises a digital voucher or currency.

6. The multi-wallet device of claim 1, wherein the payment account comprises a prepaid card account.

7. The multi-wallet device of claim 1, wherein the IC is further to:
establish a second handshake communication with a second POI device;
select the CPMW instead of the PMW;
initiate the CPMW; and
transmit, to the second POI device, an identification of the selected CPMW and a CP credential associated with the CPMW.

8. The multi-wallet device of claim 7, wherein the IC is further to:
receive and store a CP credential that is used to authenticate the user to a CP issuer that issued the CP credential for the user to access the community service,
wherein the CP credential comprises a virtual primary account number (VPAN) that is recognizable via a payment network, the VPAN being associated with a CP account number issued by a CP issuer that is responsible for facilitating the community service and the VPAN encodes an identity of the CP issuer.

9. The multi-wallet device of claim 1, wherein the CPMW comprises a health data application that interfaces with health systems, a farm data application that interfaces with farming systems, an education data application that interfaces with education systems, or a humanitarian application that interfaces with humanitarian systems.

10. The multi-wallet device of claim 1, wherein the multi-wallet device comprises a chip card form factor that includes the IC or a wearable device form factor that includes the IC.

11. A method, comprising:
storing, by a multi-wallet device, a digital identity of a user and a plurality of wallet applications comprising a community passport mobile wallet (“CPMW”) and a payment mobile wallet (“PMW”), the digital identity identifying the user across the plurality of wallet applications, the CPMW being associated with transactions involving the user to access a community service and the PMW being pre-installed in a dormant state without a payment token until activated and, when activated, is linked to a payment account;
establishing, by the multi-wallet device, a handshake communication with a point of interaction (POI) device to exchange application capabilities;
selecting, by the multi-wallet device, the PMW, instead of the CPMW, for interacting with the POI device based on the handshake communication;
initiating, by the multi-wallet device, the PMW based on the selection; and
transmitting, by the multi-wallet device, via the PMW, to the POI device, an identification of the PMW and a payment token associated with the PMW.

12. The method of claim 11, wherein prior to activating the PMW, the method further comprising:
receiving, by the multi-wallet device, during a registration process, a payment token issued to the user identified by the digital identity;
storing, by the multi-wallet device, the payment token to be accessible to the PMW; and
activating, by the multi-wallet device, responsive to receipt of the payment token, the PMW.

13. The method of claim 11, further comprising:
receiving, by the multi-wallet device, from the POI device, an indication of a load value to be loaded onto a stored value account (“SVA”) associated with the user; and
adding, by the multi-wallet device, the load value to the SVA stored locally at the multi-wallet device.

14. A community passport (“CP”) platform server that provides interoperability between CP services and payment services, comprising:
a processor to:
receive, from a wallet provider that provides a multi-wallet application stored at a multi-wallet device of a user, a digital identity of the user and a first CP token that identifies a first CP account issued to the user to access first community services of a first CP issuer, the first CP token also having been provided to the multi-wallet device;
generate a user profile comprising the digital identity of the user;
federate at least a portion of the user profile to a financial institution (FI) issuer that issues a payment account to the user based on the federated user profile, the payment account being associated with a payment token that is provided to the multi-wallet device and is stored in association with a PAN in the mapping so that the multi-wallet device is used for access to the first community service and the payment account;
generate a first account that stores first community services transaction data relating to the first community services provided to the user when the multi-wallet device is presented by the user to receive the first community services; and
generate a second account that stores payment data relating to payments made from the payment account when the multi-wallet device is presented by the user to make the payments.

15. The CP platform server of claim 14, wherein the processor is further to:
receive, from a point of interaction (“POI”) device that reads the first CP token from the multi-wallet device, the community services transaction data via an application programming interface (“API”).

16. The CP platform server of claim 15, wherein the processor is further to:
receive, from the POI device that reads the payment token from the multi-wallet device, the payment data via the API.

17. The CP platform server of claim 14, wherein a payment was made via a dedicated payment terminal that reads the multi-wallet device and transmit a payment transaction to a payment network, and wherein the processor is further to:
receive the payment data from the payment network.

18. The CP platform server of claim 14, wherein at least some of the payments are made from a stored value account (“SVA”), and wherein the processor is further to:
perform offline SVA processing to add or remove funds from the SVA based on a locally-authorized transaction via a point of interaction device with the multi-wallet device.

19. The CP platform server of claim 14, wherein at least some of the payments are made from a stored value account (“SVA”), and wherein the processor is further to:
perform online processing to add or remove funds from the SVA based on a remotely authorized transaction.

20. The CP platform server of claim 14, wherein at least some of the payments are made from via prestored digital voucher provided to the user to access the first community service.
